(19) United States
(12) Patent Application Publication
(10) Pub. No.: US 2006/0056729 A1
(43) Pub. Date: Mar. 16, 2006

(54) Fourier domain camera

(76) Inventors: W. Daniel Hillis, Encino, CA (US); Nathan P. Myhrvold, Medina, WA (US); Lowell L. Wood JR., Livermore, CA (US)

Correspondence Address: Searete LLC, Suite 110, 1756-114th Ave. S.E., Bellevue, WA, 98004, US

(21) Appl. No.: 10/941,470

(22) Filed: Sep. 15, 2004

(51) Int. Cl. G06K 9/36

(52) U.S. Cl. 382/280

(57) ABSTRACT

A method of capturing an image of a target including positioning an optical system to direct a spatial Fourier transform of a region of the target onto a field of view of a detector array; generating an electrical signal with the detector array, the electrical signal representing at least a portion of the spatial Fourier transform; generating a digital representation of the at least a portion of the spatial Fourier transform from the electrical signal; and transforming the digital representation of the at least a portion of the spatial Fourier transform to produce a digital representation of the region of the target. In addition to the foregoing, other method aspects are described in the claims, drawings, and text forming a part of the present application. Other methods and apparatuses are also disclosed.

### TECHNICAL FIELD

The present application relates, in general, to imaging objects using spatial Fourier transforms.

### SUMMARY

In one aspect, a method includes but is not limited to positioning an optical system to direct a spatial Fourier transform of a region of the target onto a field of view of a detector array; generating an electrical signal with the detector array, the electrical signal representing at least a portion of the spatial Fourier transform; generating a digital representation of the at least a portion of the spatial Fourier transform from the electrical signal; and transforming the digital representation of the at least a portion of the spatial Fourier transform to produce a digital representation of the region of the target. In addition to the foregoing, other method aspects are described in the claims, drawings, and text forming a part of the present application.

In another aspect, a camera includes but is not limited to a detector array that produces an electrical signal corresponding to at least a portion of light incident on the detector array; a conversion circuit that converts the electrical signal to digital data; an optical system aligned to direct the light to a field of view of the detector array, the optical system and detector array being relatively positioned to produce a spatial Fourier transform of an image field of the detector array; and a signal processor operably couplable to the conversion circuit to receive the digital data, the signal processor including a program that performs a inverse Fourier transform on the digital data to produce a real space representation of the image field. In addition to the foregoing, other aspects are described in the claims, drawings, and text forming a part of the present application.

In another aspect, a system includes but is not limited to an apparatus for producing a spatial Fourier transform of a region of the target; an apparatus for detecting the spatial Fourier transform; an apparatus for directing the spatial Fourier transform into a purview of the means for detecting the spatial Fourier transform; an apparatus for generating an electrical signal from the detected spatial Fourier transform, the electrical signal corresponding to at least a portion of the spatial Fourier transform; an apparatus for obtaining a digital representation of the spatial Fourier transform from the electrical signal; and an apparatus for transforming the digital representation of the spatial Fourier transform into a digital representation of the region of the target. In addition to the foregoing, other system aspects are described in the claims, drawings, and text forming a part of the present application.

In one or more various aspects, related systems include but are not limited to circuitry and/or programming and/or electromechanical devices and/or optical devices for effecting the herein-referenced method aspects; the circuitry and/or programming and/or electromechanical devices and/or optical devices can be virtually any combination of hardware, software, and/or firmware configured to effect the herein-referenced method aspects depending upon the design choices of the system designer skilled in the art.

In addition to the foregoing, various other method and/or system aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, inventive features, and advantages of the devices and/or processes described herein, as defined solely by the claims, will become apparent in the detailed description set forth herein.

### BRIEF DESCRIPTION OF THE FIGURES

FIG. 1 is a flow chart depicting an embodiment of the subject matter of the present application;

FIG. 2 is a flow chart depicting another embodiment of the subject matter of the present application;

FIG. 3 is a flow chart depicting another embodiment;

FIG. 4 is a flow chart depicting another embodiment;

FIG. 5 is a flow chart depicting another embodiment;

FIG. 6 is a flow chart depicting another embodiment;

FIG. 7 is a flow chart depicting another embodiment;

FIG. 8 is a block diagram of another embodiment; and

FIG. 9 is a block diagram of another embodiment.

The use of the same symbols in different drawings typically indicates similar or identical items.

### DETAILED DESCRIPTION

Following are a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations.

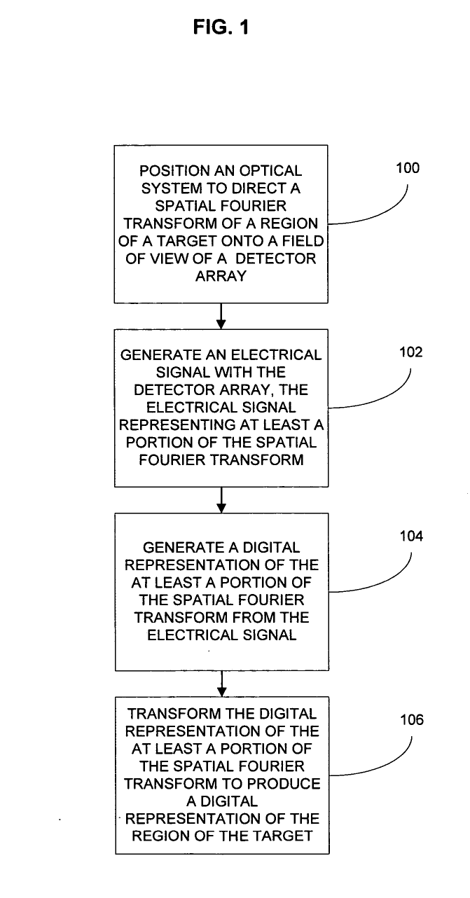

With reference now to FIG. 1, shown is an example of a method of capturing an image of a target that may serve as a context for introducing one or more processes and/or devices described herein. The method shown includes positioning an optical system to direct a spatial Fourier transform of a region of the target onto a field of view of a detector array (step 100); generating an electrical signal with the detector array, the electrical signal representing at least a portion of the spatial Fourier transform (step 102); generating a digital representation of the at least a portion of the spatial Fourier transform from the electrical signal (step 104); and transforming the digital representation of the at least a portion of the spatial Fourier transform to produce a digital representation of the region of the target (step 106).

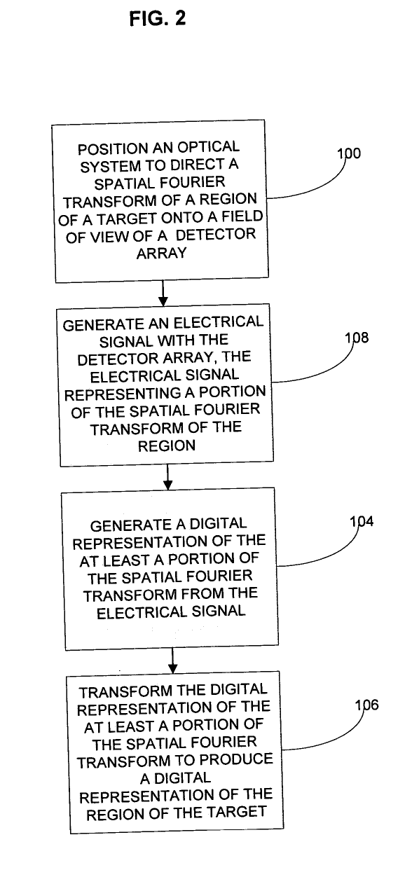

FIG. 2 shows another embodiment, a method of capturing an image of a target, that includes step 100, 104 and 106, and, in addition, generating an electrical signal with the detector array, the electrical signal, wherein the electrical signal represents a substantial portion of the spatial Fourier transform of the region (step 108).

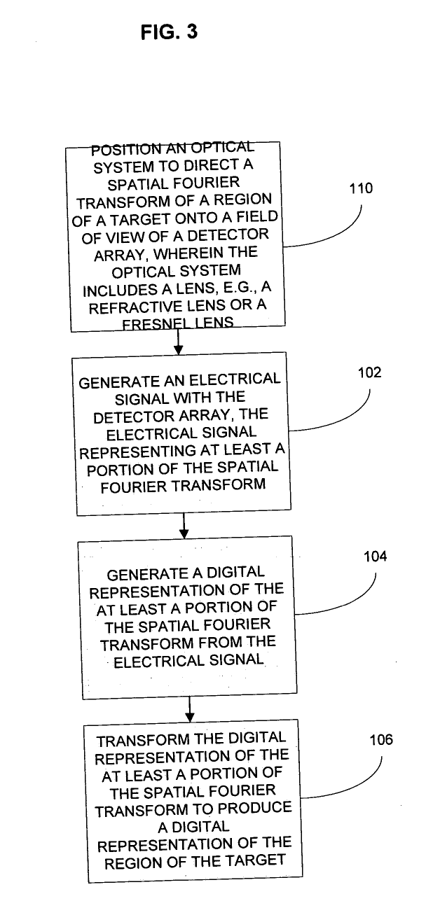

Another embodiment, a method of capturing an image of a target, is shown in FIG. 3. This embodiment includes steps 102, 104 and 106 as described above, and, in addition, step 110, positioning an optical system to direct a spatial Fourier transform of a region of the target onto a field of view of a detector array, wherein the optical system includes a lens, e.g., a refractive lens or a Fresnel lens.

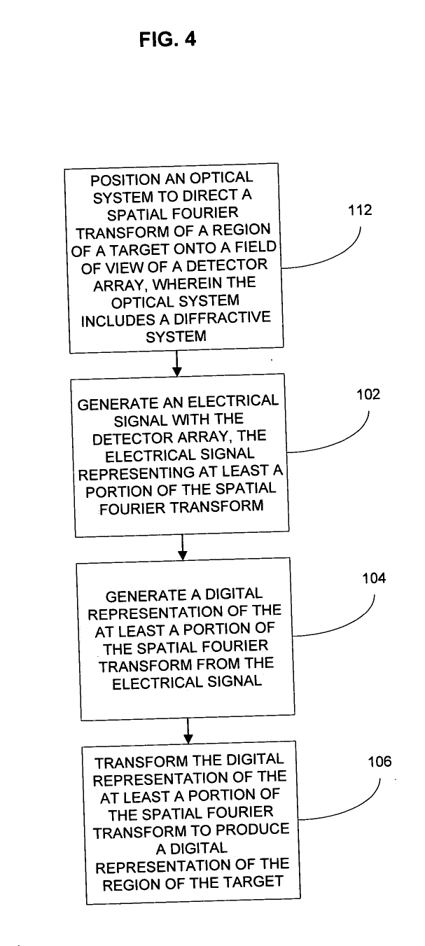

FIG. 4 shows another embodiment, a method of capturing an image of a target, including the steps 102, 104 and 106 as described above, and, in addition, positioning an optical system to direct a spatial Fourier transform of a region of the target onto a field of view of a detector array, wherein the optical system includes a diffractive system (step 112).

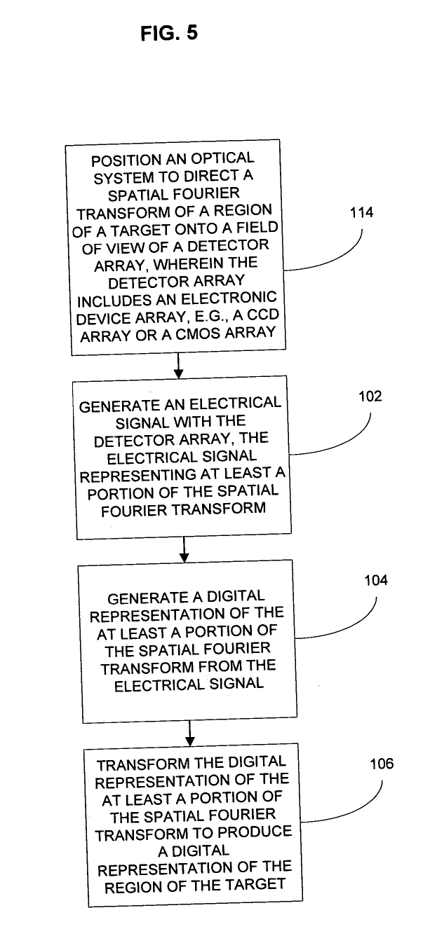

Another embodiment, a method of capturing an image of a target, is shown in FIG. 5. This embodiment includes steps 102, 104 and 106 as described above, and, in addition, step 114, positioning an optical system to direct a spatial Fourier transform of a region of the target onto a field of view of a detector array, wherein the detector array includes an electronic device array, e.g., a charge-coupled device (“CCD”) array or a complementary metal oxide semiconductor (“CMOS”) array.

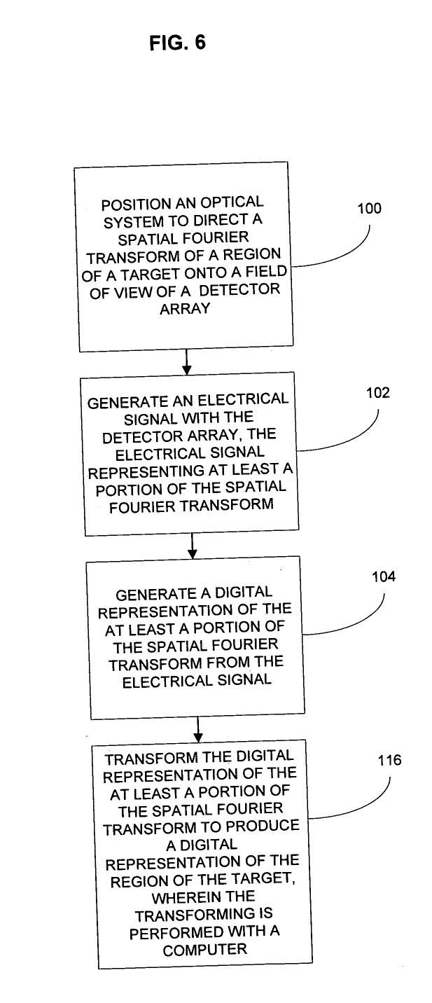

FIG. 6 shows another embodiment, a method of capturing an image of a target, including steps 100, 102 and 104 as described above, and, in addition, step 116, transforming the digital representation of the at least a portion of the spatial Fourier transform to produce a digital representation of the region of the target, wherein the transforming is performed with a computer.

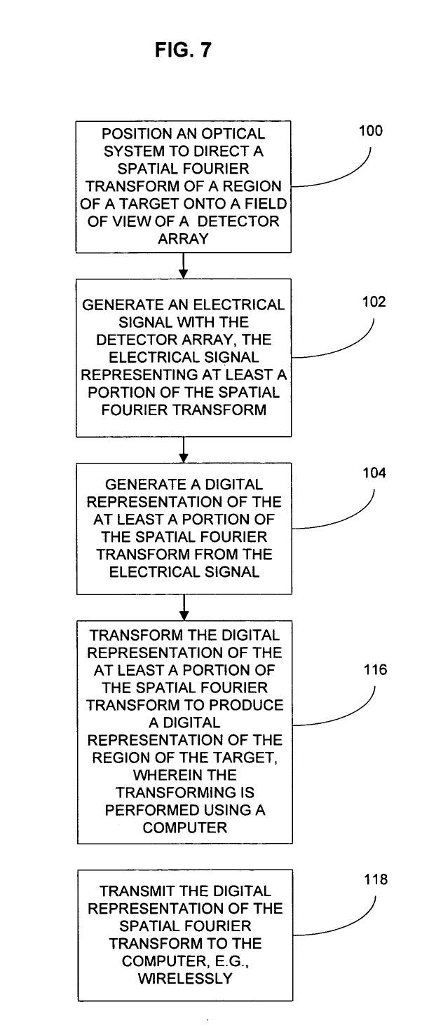

FIG. 7 shows another embodiment, a method of capturing an image of a target, including steps 100, 102, 104 and 116, and in addition, step 118, transmitting the digital representation of the spatial Fourier transform to the computer, e.g., wirelessly.

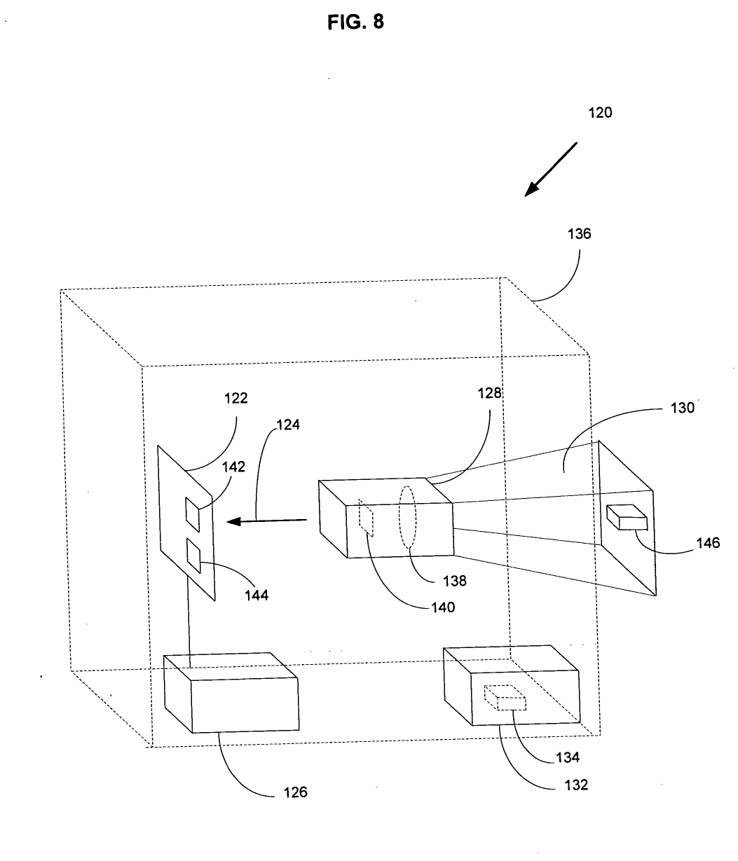

FIG. 8 shows another embodiment, a camera 120 that includes a detector array 122 that produces an electrical signal corresponding to at least a portion of light 124 incident on the detector array 122; a conversion circuit 126 that converts the electrical signal to digital data; an optical system 128 aligned to direct the light 126 to a field of view of a detector array 122 (notice that in other implementations, the light may be directed onto a field of view of the detector array, such as onto a portion of a wall within the field of the photo-detector array), the optical system 128 and detector array 122 being relatively positioned to produce a spatial Fourier transform of an image field 130 of the detector array 122; and a signal processor 132 operably couplable to the conversion circuit 126 to receive the digital data, the signal processor 132 including a program (not shown) that performs an inverse Fourier transform on the digital data to produce a real space representation of the image field 130. The signal processor 132 may include a microprocessor 134. The signal processor 132 may be carried by a camera body 136.

The signal processor 132 and the conversion circuit 126 may be coupled wirelessly. The optical system 128 may include a lens 138, e.g., a refractive lens or a Fresnel lens. The optical system may include a diffractive system 140. The detector array 122 may include a CCD array 142 or a CMOS array 144. The image field may contain a target 146.

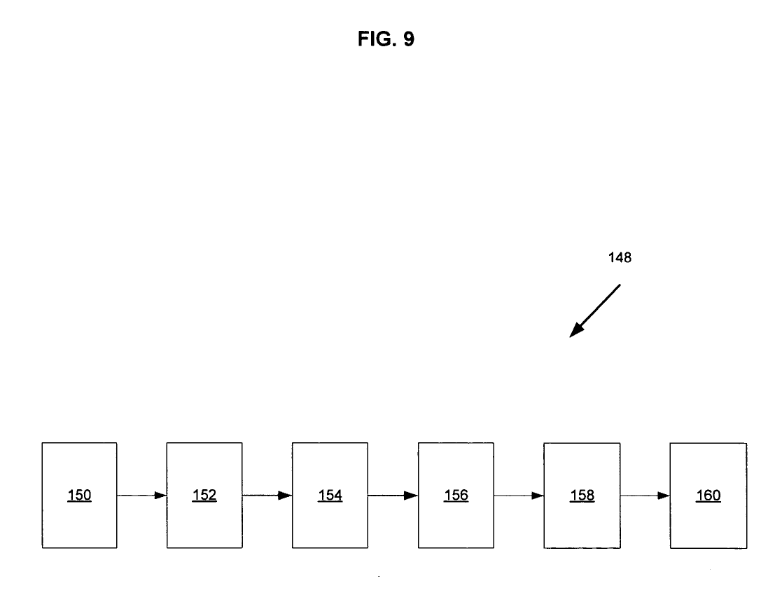

FIG. 9 shows another embodiment, an apparatus 148 for obtaining an image of a target, including an imaging electromechanical device configurable to produce a spatial Fourier transform of a region of the target 150; circuitry for detecting the spatial Fourier transform 152; a directing electromechanical device configurable to direct the spatial Fourier transform into a purview of the circuitry for detecting the spatial Fourier transform 154; circuitry for generating an electrical signal from the detected spatial Fourier transform 156, the electrical signal corresponding to at least a portion of the spatial Fourier transform; circuitry for obtaining a digital representation of the spatial Fourier transform from the electrical signal 158; and circuitry for transforming the digital representation of the spatial Fourier transform into a digital representation of the region of the target 160.

Step 100, as described above may be performed with, e.g., the image field 130 (where the image field 130 includes a target 146), the detector array 122 (which may include the CCD array 142 and/or the CMOS array 144), and the light 124 depicted in FIG. 8. Steps 102 and 108 may be performed with, e.g., the optical system 128, the detector array 122, the light 124, and the conversion circuit 126 shown in FIG. 8. Step 104 as described above may be performed with, e.g., the optical system 128, and the conversion circuit 126, illustrated in FIG. 8. Step 106 may be performed with, e.g., the signal processor 132 (which may include, e.g., the microprocessor 134, and which may be carried by the camera body 136) illustrated in FIG. 8. Step 110 as described above may be performed with, e.g., the optical system 128, the image field 130 (where the image field 130 includes a target 146), the detector array 122 (which may include the CCD array 142 and/or the CMOS array 144), the light 124, and the lens 138 depicted in FIG. 8. Step 112 as described above may be performed with, e.g., the image field 130 (where the image field 130 includes a target 146), the detector array 122 (which may include the CCD array 142 and/or the CMOS array 144), the light 124, and the diffractive system 140 depicted in FIG. 8. Step 114 as described above may be performed with, e.g., the image field 130 (where the image field 130 includes a target 146), the detector array 122 (which includes the CCD array 142 and/or the CMOS array 144), and the light 124 depicted in FIG. 8. Steps 116 and 118 as described above may be performed with, e.g., a computer including the signal processor 132 (which may include, e.g., the microprocessor 134) shown in FIG. 8.

One skilled in the art will recognize that the foregoing components (e.g., steps), devices, and objects in FIGS. 1-9 and the discussion accompanying them are used as examples for the sake of conceptual clarity and that various configuration modifications are common. Consequently, as used herein, the specific exemplars set forth in FIGS. 1-9 and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed.

For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will require optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various embodiments described herein can be implemented, individually and/or collectively, by various types of electromechanical systems having a wide range of electrical components such as hardware, software, firmware, or virtually any combination thereof; and a wide range of components that may impart mechanical force or motion such as rigid bodies, spring or torsional bodies, hydraulics, and electro-magnetically actuated devices, or virtually any combination thereof. Consequently, as used herein “electro-mechanical system” includes, but is not limited to, electrical circuitry operably coupled with a transducer (e.g., an actuator, a motor, a piezoelectric crystal, etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), electrical circuitry forming a communications device (e.g., a modem, communications switch, or optical-electrical equipment), and any non-electrical analog thereto, such as optical or other analogs. Those skilled in the art will also appreciate that examples of electromechanical systems include but are not limited to a variety of consumer electronics systems, as well as other systems such as motorized transport systems, factory automation systems, security systems, and communication/computing systems. Those skilled in the art will recognize that electromechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into image processing systems. That is, at least a portion of the devices and/or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position and/or velocity; control motors for moving/distorting lenses to give desired focuses. A typical image processing system may be implemented utilizing any suitable commercially available components, such as those typically found in digital still systems and/or digital motion systems.

Those skilled in the art will recognize that it is common within the art to describe devices and/or processes in the fashion set forth herein, and thereafter use standard engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

Those skilled in the art will recognize that it is common within the art to describe devices and/or processes in the fashion set forth herein, and thereafter use standard engineering practices to integrate such described devices and/or processes into mote processing systems. That is, at least a portion of the devices and/or processes described herein can be integrated into a mote processing system via a reasonable amount of experimentation. Those having skill in the art will recognize that a typical mote processing system generally includes one or more of a memory such as volatile and non-volatile memory, processors such as microprocessors and digital signal processors, computational entities such as operating systems, user interfaces, drivers, sensors, actuators, applications programs, one or more interaction devices, such as USB ports, control systems including feedback loops and control motors (e.g., feedback for sensing position and/or velocity; control motors for moving and/or adjusting components and/or quantities). A typical mote processing system may be implemented utilizing any suitable available components, such as those typically found in mote computing/communication systems, combined with standard engineering practices. Specific examples of such components entail such as Intel Corporation's mote components and supporting hardware, software, and firmware as well as the Defense Advanced Research Project's (DARPA's) network embedded sensor technologies.

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components.

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

Other embodiments are within the following claims.

We claim:

1. A method of capturing an image of a target, comprising:
positioning an optical system to direct a spatial Fourier transform of a region of the target onto a field of view of a detector array;
generating an electrical signal with the detector array, the electrical signal representing at least a portion of the spatial Fourier transform;
generating a digital representation of the at least a portion of the spatial Fourier transform from the electrical signal; and
transforming the digital representation of the at least a portion of the spatial Fourier transform to produce a digital representation of the region of the target.

2. The method of claim 1 wherein the electrical signal represents a substantial portion of the spatial Fourier transform of the region.

3. The method of claim 1 wherein the optical system includes a lens.

4. The method of claim 3 wherein the lens is a refractive lens.

5. The method of claim 3 wherein the lens is a Fresnel lens.

6. The method of claim 1 wherein the optical system includes a diffractive system.

7. The method of claim 1 wherein the detector array includes a charge-coupled device array.

8. The method of claim 1 wherein the detector array includes a complementary metal oxide semiconductor array.

9. The method of claim 1 wherein the transforming includes computing an inverse Fourier transform.

10. The method of claim 1 wherein the transforming is performed with a computer.

11. The method of claim 10 further including transmitting the digital representation of the spatial Fourier transform to the computer.

12. The method of claim 11 wherein the transmitting the digital representation of the spatial Fourier transform to the computer is performed wirelessly.

13. An apparatus for obtaining an image of a target, comprising:
means for producing a spatial Fourier transform of a region of the target;
means for detecting the spatial Fourier transform;
means for directing the spatial Fourier transform into a purview of the means for detecting the spatial Fourier transform;
means for generating an electrical signal from the detected spatial Fourier transform, the electrical signal corresponding to at least a portion of the spatial Fourier transform;
means for obtaining a digital representation of the spatial Fourier transform from the electrical signal; and
means for transforming the digital representation of the spatial Fourier transform into a digital representation of the region of the target.

14. A camera comprising:
a detector array that produces an electrical signal corresponding to at least a portion of light incident on the detector array;
a conversion circuit that converts the electrical signal to digital data;
an optical system aligned to direct the light to a field of view of the detector array, the optical system and detector array being relatively positioned to produce a spatial Fourier transform of an image field of the detector array; and
a signal processor operably couplable to the conversion circuit to receive the digital data, the signal processor including a program that performs an inverse Fourier transform on the digital data to produce a real space representation of the image field.

15. The camera of claim 14 wherein the signal processor includes a microprocessor.

16. The camera of claim 14 further including a camera body, wherein the signal processor is carried by the camera body.

16. The camera of claim 14 wherein the signal processor and the detector array are wirelessly coupled.

18. The camera of claim 14 wherein the electrical signal corresponds to a substantial portion of the light incident on the detector array.

19. The camera of claim 14 wherein the optical system includes a lens.

20. The camera of claim 19 wherein the lens is a refractive lens.

21. The camera of claim 19 wherein the lens is a Fresnel lens.

22. The camera of claim 14 wherein the optical system includes a diffractive system.

23. The camera of claim 14 wherein the detector array includes a charge-coupled array.

24. The camera of claim 14 wherein the detector array includes a complementary metal oxide semiconductor array.

25. A system of capturing an image of a target, comprising:
a positioning electromechanical system configurable to position an optical system to direct a spatial Fourier transform of a region of the target onto a field of view of a detector array;
circuitry for generating an electrical signal with the detector array, the electrical signal representing at least a portion of the spatial Fourier transform;
circuitry for generating a digital representation of the at least a portion of the spatial Fourier transform from the electrical signal; and
circuitry for transforming the digital representation of the at least a portion of the spatial Fourier transform to produce a digital representation of the region of the target.

26. A system comprising:
means for positioning an optical system to direct a spatial Fourier transform of a region of a target onto a field of view of a detector array;
means for generating an electrical signal with the detector array, the electrical signal representing at least a portion of the spatial Fourier transform;
means for generating a digital representation of the at least a portion of the spatial Fourier transform from the electrical signal; and
means for transforming the digital representation of the at least a portion of the spatial Fourier transform to produce a digital representation of the region of the target.
